(19) United States
(12) Patent Application Publication
(10) Pub. No.: US 2025/0145178 A1
(43) Pub. Date: May 8, 2025

(54) TRAJECTORY GENERATION FOR MOBILE AGENTS

(71) Applicant: Five AI Limited, Cambridge (GB)

(72) Inventor: Anthony Knittel, Cambridge (GB)

(73) Assignee: Five AI Limited, Cambridge (GB)

(21) Appl. No.: 18/835,462

(22) PCT Filed: Feb. 2, 2023
(86) PCT No.: PCT/EP2023/052612

§ 371 Date: Aug. 2, 2024

(30) Foreign Application Priority Data
Feb. 3, 2022 (GB) 2201398.1

(51) Int. Cl. B60W 60/00; B60W 30/09; B60W 30/095; G06N 3/045

(52) U.S. Cl. CPC B60W 60/0011; B60W 30/09; B60W 30/0956; B60W 60/0015; B60W 60/00274; G06N 3/045; B60W 2554/4041; B60W 2554/4044; B60W 2556/40

(57) ABSTRACT

A computer-implemented method is provided for generating a trajectory for a first agent of a plurality of agents navigating a mapped area, the method comprising: receiving an observed state of each of the plurality of agents, and map data of the mapped area; generating an initial estimated trajectory for each of the plurality of agents based on the observed state of each agent and the map data; performing a first collision assessment to determine a likelihood of collision between the first agent and each other agent, based on the initial estimated trajectory for the first agent and the initial estimated trajectory for each other agent; and generating a second estimated trajectory for the first agent based on the observed states of each of the plurality of agents, the map data, and the results of the first collision assessment.

### TECHNICAL FIELD

The present disclosure pertains to trajectory generation for mobile agents. The present techniques have various application in autonomous driving and robotics more generally.

### BACKGROUND

In the field of autonomous driving and robotics more generally, generating realistic trajectories is an important task, where trajectories define the state of a given agent over time. In prediction, the task of predicting the behaviour of agents, such as vehicles, pedestrians and other road users, is important in order for the autonomous vehicle to plan a safe route. In planning, planned trajectories need to be generated in a given scenario that it is possible for a robot (the ego robot) to follow.

Some existing methods of trajectory estimation use deep neural networks to generate predicted trajectories for a set of agents based on a set of state histories for those agents. An example of such a method is disclosed in Deo, Nachiket, and Mohan M. Trivedi. “Convolutional social pooling for vehicle trajectory prediction.” Proceedings of the IEEE Conference on Computer Vision and Pattern Recognition Workshops. 2018. In this method, the output of the trajectory generation network is a distribution over a set of co-ordinates defining the position of the agent over a plurality of future timesteps.

Neural networks have also been deployed in robotic planners that plan trajectories for an ego vehicle/agent. The use of a neural network to generate a trajectory for an autonomous ego vehicle could lead to unpredictable and dangerous trajectories being planned. WO2021/152047 teaches a multi-stage planning architecture, in which a neural network trajectory generator seeds a constrained optimization stage. The latter is guaranteed to produce a safe trajectory (within defined constraints), but the quality of the final trajectory is dependent on the quality of the seed trajectory generated by the neural network.

Another method disclosed in Vitelli, Matt, et al. “SafetyNet: Safe planning for real-world self-driving vehicles using machine-learned policies.” arXiv preprint arXiv: 2109.13602 (2021), employs a neural-network-based planner trained on expert driving examples to generate trajectories, and checks the trajectories according to a set of requirements including dynamic feasibility, legality and collision probability. If the trajectory generated by the network fails on any of these requirements, the system reverts to a fallback trajectory generated using an existing rule-based trajectory method.

Other trajectory planning methods use ‘classical’ probabilistic methods using Bayesian reasoning to determine a best trajectory for a mobile agent, given information on the agent's past behaviour as well as the state of other agents. Such techniques are described, for example, in International Patent Publication No. WO 2020/079066.

### SUMMARY

When determining a trajectory for a given agent, it is important to consider how that agent will interact with other agents of the given scenario. The behaviour of each agent affects the behaviour of other agents of the scenario, making prediction difficult for multiple agents that could potentially interact. Using neural networks, interactions may be implicitly learned from training data comprising agent trajectories, such that the set of trajectories predicted by a network for a set of interacting agents generally reflects a likely real-world set of interacting trajectories. However, this requires a large amount of data in order to accurately predict trajectories for a given configuration of agents.

Disclosed herein is a method of generating a trajectory for a mobile agent in the presence of other agents, taking possible future interactions between agents into account. The methods described herein apply a hierarchical approach in order to determine, at a first level (referred to as level 0), an initial set of candidate trajectories for agents of a given scene. A collision assessment is then performed on each of the candidate trajectories to assess a likelihood of that trajectory colliding with any of the candidate trajectories for other agents of the scene. Once the collision assessment is performed, the results for each candidate trajectory are used as input to a higher-level trajectory generator that considers the current and previous states of each agent, as well as the collision assessment for the candidate trajectories generated by the level-0 trajectory generator. The higher-level trajectory generator is trained to generate candidate trajectories by reasoning about collision probabilities between possible trajectories of the different agents present in a given scene.

A first aspect disclosed herein provides a computer-implemented method of generating a trajectory for a first agent of a plurality of agents navigating a mapped area, the method comprising: receiving an observed state of each of the plurality of agents, and map data of the mapped area; generating an initial estimated trajectory for each of the plurality of agents based on the observed state of each agent and the map data; performing a first collision assessment to determine a likelihood of collision between the first agent and each other agent, based on the initial estimated trajectory for the first agent and the initial estimated trajectory for each other agent; and generating a second estimated trajectory for the first agent based on the observed states of each of the plurality of agents, the map data, and the results of the first collision assessment.

The initial estimated trajectory may be generated by a first neural network configured to receive the observed state of each agent and the map data as inputs, wherein the second estimated trajectory is generated by a second neural network configured to receive the observed state of each agent, the map data, and the collision assessment results.

The method may comprise generating a second estimated trajectory for each of the plurality of agents based on the observed state of each agent and the map data; performing a second collision assessment to determine a likelihood of collision between the first agent and each other agent of the plurality of agents, based on the second estimated trajectory for each of the plurality of agents; and generating a third estimated trajectory for the first agent based on the observed states of each of the plurality of agents, the map data, and the results of the second collision assessment.

The third estimated trajectory may be further based on the results of the first collision assessment.

Each of the estimated trajectories may comprise a series of states for the respective agent, the state defining the position and motion of the agent.

Generating each of the estimated trajectories may comprise generating, by the respective neural network, a set of weights corresponding to a set of trajectory basis elements, weighting each trajectory basis element by its corresponding weight, and combining the weighted trajectory basis elements to generate a trajectory.

Generating each of the estimated trajectories may comprise directly generating, by the respective neural network, a time sequence of states defining the trajectory of the agent.

The first or second collision assessment may comprise computing a collision probability defining a probability that an agent following the estimated trajectory collides with any other agent of the plurality of agents following any of that agent's respective estimated trajectories.

The trajectory basis elements may comprise multiple basis paths, the weighted basis paths combined to form a path, the estimated trajectory comprising the path.

The trajectory basis elements may comprise multiple basis motion profiles, the weighted basis motion profiles combined to form a motion profile, the estimated trajectory comprising the motion profile.

The basis motion profiles may be generated based on the observed state of the first agent and one or more motion profile parameters.

The method may be applied to plan a trajectory for an ego agent, wherein the first agent is the ego agent and the trajectory generation comprises generating a candidate planned trajectory for the ego agent.

The candidate planned trajectory may be used to seed a runtime optimizer that generates a final planned trajectory for the agent.

A second aspect disclosed herein provides a method of training a trajectory generation system for generating a trajectory for a first agent of a plurality of agents navigating a mapped area, the method comprising: receiving a set of training date comprising a set of training inputs, each input comprising an observed state of each of the plurality of agents, and map data of the mapped area, and a corresponding ground truth outputs, each ground truth output comprising an actual trajectory of the first agent from the observed state; processing the observed state of each agent and the map data in a first neural network of the trajectory generation system to generate an initial estimated trajectory for each of the plurality of agents; performing a collision assessment to determine a likelihood of collision between the first agent and each other agent, based on the initial estimated trajectory for the first agent and the initial estimated trajectory for each other agent; processing the observed states of each of the plurality of agents, the map data, and the collision assessment results in a second neural network of the trajectory generation system to generate a second estimated trajectory for the first agent; and computing an update to the parameters of each of the first and second networks of the trajectory generation system based on a loss function that penalises deviations between the initial estimated trajectory for the first agent and the corresponding ground truth output for the first agent, and deviations between the second estimated trajectory for the first agent and the corresponding ground truth output for the first agent.

Further aspects disclosed herein provide a computer system comprising computer memory and one or more processors configured to carry out the method of any method disclosed herein, and a computer program comprising executable instructions, which, when executed by one or more processors, cause the processors to implement any method disclosed herein.

### BRIEF DESCRIPTION OF FIGURES

To assist understanding of the present invention, and to show how embodiments of the same may be carried into effect, reference is made by way of example only to the accompanying drawings, in which:

FIG. 1 shows a schematic block diagram of an autonomous vehicle runtime stack;

FIG. 2 shows a schematic block diagram of a multi-level prediction system for generating predicted trajectories for a plurality of agents;

FIG. 3 shows a schematic block diagram of a trajectory generation system for directly generating trajectories;

FIG. 4 shows a schematic block diagram of a trajectory generation system for generating trajectories in terms of trajectory basis elements;

FIG. 5 shows an example architecture of a neural network trajectory generation network;

FIG. 6 shows the training of a trajectory generation network;

FIG. 7 shows an example set of basis paths from which a predicted path is generated;

FIG. 8 shows an example implementation of a trajectory generation network in a planning system;

FIG. 9 shows a visualisation of spatial uncertainty distributions predicted by a trajectory generation network; and

FIG. 10 shows an example collision assessment between trajectory predictions of two agents.

### DETAILED DESCRIPTION

To provide relevant context to the described embodiments, further details of an example form of autonomous vehicle (AV) stack will now be described.

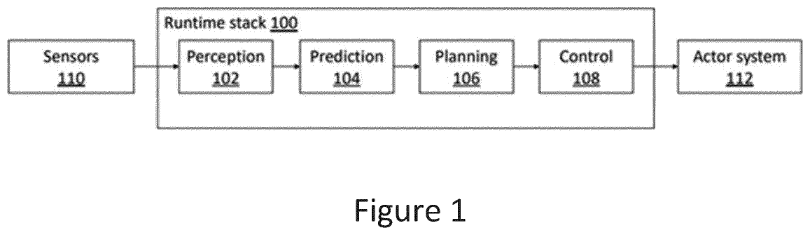

FIG. 1 shows a highly schematic block diagram of an AV runtime stack 100. The run time stack 100 is shown to comprise a perception (sub-) system 102, a prediction (sub-) system 104, a planning (sub-) system (planner) 106 and a control (sub-) system (controller) 108. The term (sub-) stack may also be used to describe each of the aforementioned components 102-108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

In a real-world context, the planning system 106 and other components of the AV stack of FIG. 1 may be implemented as components on-board a vehicle. When applied for testing the performance of an AV stack, the planning system 106 may be applied offline in simulation to plan a trajectory for a simulated ego vehicle in one or more simulated scenarios, and the behaviour of the ego vehicle and other agents of the scenario may be simulated based on outputs of the planning and prediction stacks and vehicle dynamics models. References herein to planning and prediction for ego and other agents refer to prediction and planning of trajectories in both a real-world context, in which a prediction component on-board an autonomous vehicle determines in real-time the likely behaviour of agents in a scenario, and where an on-board planner generates a suitable trajectory for the ego vehicle, which is executed by sending control signals to an actor system which controls the vehicle, and in a simulation context, in which a set of possible agent trajectories can be generated by a prediction component running offline on a simulated scenario, and where the ego trajectory is generated by an offline planner and executed in simulation using a behaviour model.

The planning system 106 may reason into the future, such that the planned trajectory at each planning step extends beyond the next planning step. Any individual planned trajectory may, therefore, not be fully realized (if the planning system 106 is tested in isolation, in simulation, the ego agent may simply follow the planned trajectory exactly up to the next planning step; however, as noted, in other real and simulation contexts, the planned trajectory may not be followed exactly up to the next planning step, as the behaviour of the ego agent could be influenced by other factors, such as the operation of the control system 108 and the real or modelled dynamics of the ego vehicle). In many testing contexts, the actual trajectory of the ego agent is what ultimately matters; in particular, whether the actual trajectory is safe, as well as other factors such as comfort and progress. However, the rules-based testing approach herein can also be applied to planned trajectories (even if those planned trajectories are not fully or exactly realized by the ego agent). For example, even if the actual trajectory of an agent is deemed safe according to a given set of safety rules, it might be that an instantaneous planned trajectory was unsafe; the fact that the planner 106 was considering an unsafe course of action may be revealing, even if it did not lead to unsafe agent behaviour in the scenario. Instantaneous planned trajectories constitute one form of internal state that can be usefully evaluated, in addition to actual agent behaviour in the simulation. Other forms of internal stack state can be similarly evaluated.

It will be appreciated that the term “stack” encompasses software, but can also encompass hardware. In simulation, software of the stack may be tested on a “generic” off-board computer system before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

Components of an AV stack as described herein, including prediction and planning systems may be implemented as part of a reference stack, which can be used for comparison with an external AV stack for performance testing of that external stack. For example, a planner system 106 as described herein may be provided as a reference planner in order to test the performance of another planner which may be implemented, for example as a runtime planner for an autonomous vehicle. The overall performance of the AV stack described herein may be compared with that of an external stack on the same real or simulated scenarios in order to provide a relative measure of performance for that external stack.

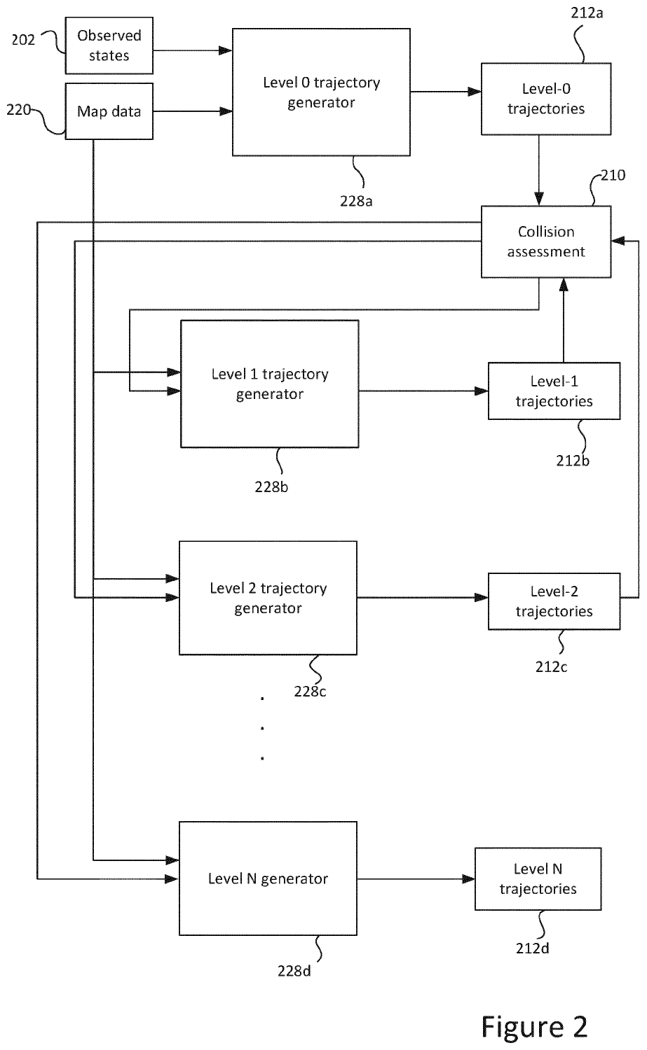

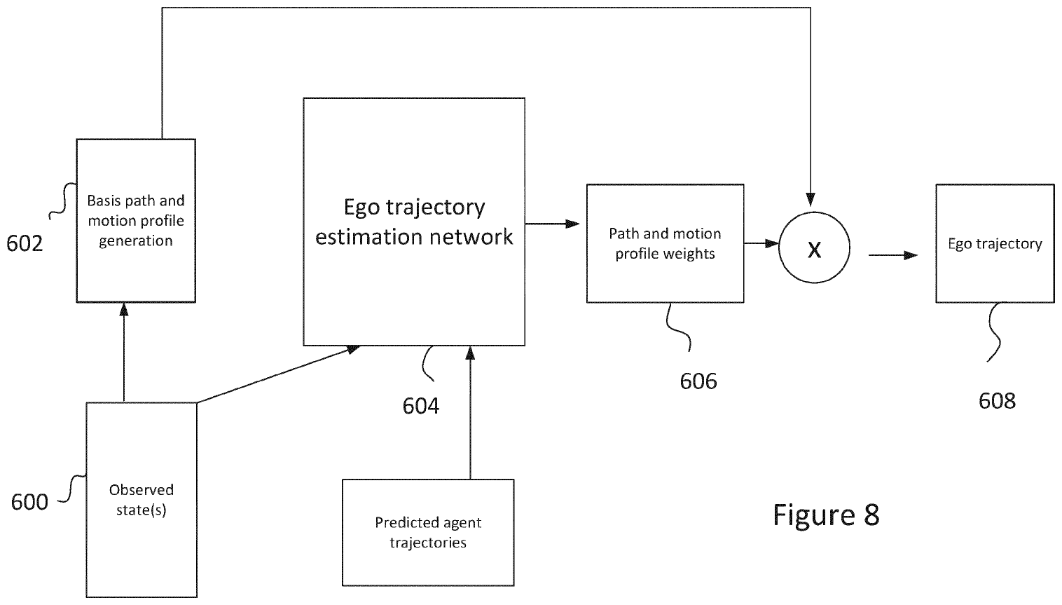

An example prediction system using neural networks to generate trajectories, taking into account interaction between agents, will now be described with reference to FIG. 2. The description refers to applications of such a system for predicting agent trajectories, for example by the prediction system 104, to determine predicted trajectories of external agents of a driving scenario, based on which an ego trajectory may be planned by the planner 106. However, as described in further detail with reference to FIG. 8, the generation of trajectories based on a set of basis elements is applicable to more than prediction, and can also be used for example to plan realistic trajectories for an ego agent, which could be used to initialise an ego planning component as described further below.

FIG. 2 shows an example architecture for a trajectory generation system to generate trajectories for a set of agents at multiple levels, with the first level generating an initial set of trajectories for the agents based on the current and/or past states of the agents and the map data describing the environment, and with each subsequent level taking as a further input the results of a collision assessment result determined for the trajectories output from the previous level. This may be implemented by the prediction system 104 or the planner 106. The trajectory generation system generates a future trajectory for at least one agent of the scenario, with the future trajectory defining the state of the agent over a sequence of future timesteps.

An observed state 202 and map data 220 is input to the level 0 trajectory generator. The observed state 202 includes, for example, a position and orientation for each agent as well as motion parameters of the agent such as velocity or acceleration. In one example implementation, the state includes the position of each agent in the scene as defined by coordinates (x,y) and a yaw angle indicating the orientation of the agent's path with respect to the forward direction, as well as a kinematic state with a velocity, acceleration and jerk. In addition to the current state, multiple previous states for each agent may be received, defining a ‘trace’ of the agent over a past time interval. Map data is also received, which describes static elements of the scene, such as the road and lane boundaries, and road features such as junctions and roundabouts. This information may be derived from a map of the scenario region or from sensor data such as camera images, lidar, radar, etc. It should be noted that the term ‘map data’ is used herein to refer to any data relating to static elements of a scenario or environment, including data derived from sensor data, and not just data derived from a map.

The level 0 trajectory generator 228a may comprise a neural network that is trained to take observed states of agents, along with static information about the environment in which the agents exist, and to generate trajectories for each of the agents of the scene. In some embodiments, as described in more detail below, a path generator is used to determine a set of basis paths for each agent, as well as basis motion profiles defining a set of motion coordinates such as speed, acceleration and jerk for each agent over a set of timesteps for which a trajectory is predicted. In this embodiment, the set of basis trajectories are input to the trajectory generator neural network which is trained to output trajectories defined as weighted combinations of the basis paths and basis motion profiles. In this case, the possible goals of each agent and a corresponding goal likelihood for each goal may be determined, which can be provided as a further input to the trajectory generator. These further inputs (i.e. agent goals and likelihoods) are not shown in FIG. 2. Alternatively, the agent states and map data may be processed by a neural network which is trained to directly output a set of agent states (i.e. as a sequence of positions, orientation, speeds, etc. over a time interval for each agent). In this case, goal prediction is not performed.

Alternatively, the level 0 trajectory generator 228a, and the trajectory generators at all other levels, may be based on ‘classical’ trajectory prediction methods such as Bayesian methods, to generate a trajectory based on a set of observed states, wherein the collision assessment at previous levels informs the trajectory generation at the next level. For example, trajectory generation may be performed using inverse planning, as described in International Patent Publication No. WO 2020/079066, which is hereby incorporated by reference in its entirety. In the embodiments described below, the trajectory generation system is implemented by neural networks, but it should be noted that in other embodiments, such ‘classical’ trajectory generators may be used in place of the trajectory generation networks provided in the example embodiments described.

Goals can be identified by constructing a graph representation of a drivable region, for example, a section of road up to a predefined distance. The graph may comprise a set of waypoints along the centre of each drivable lane of the road. In a highway example, the drivable region comprises three lanes, with a single direction of traffic, and the graph representation comprises waypoints along three lines at the centre of each lane of the highway. All graph traversals from a given starting point along a specific distance of road can be traversed, and a final waypoint at each lane of the road can be maintained as a goal waypoint. Thus, for a starting point in the centre of the leftmost lane and an example distance of 200 m, the possible goals are (a) to follow the current lane, corresponding to a goal waypoint in the leftmost lane, (b) to change to the centre lane, performing a lane change at some point along the 200 m of road, this goal corresponding to the goal waypoint at the end of the given section of the centre lane, or (c) to move into the rightmost lane, thereby changing lanes twice, with this goal corresponding to a goal waypoint 200 m ahead in the right lane. A goal is defined for all lanes for which a graph traversal is possible from the given starting point, so for example at junctions and roundabouts, a goal is defined for all possible turns and/or exits.

A goal waypoint may also be defined outside of the road layout, representing a continuation of an existing agent behaviour. For example, where the current state, and optionally one or more historical states, of a given agent indicates that the agent is veering off the road represented by the lane graph, a goal representing the continuation of the agent's current trajectory at its current velocity, or the continuation of the agent's current path at a current acceleration/deceleration and/or curvature may be generated by defining a waypoint for that goal, as well as a target kinematic state, and fitting splines to the respective waypoints, thereby generating an additional basis path and motion profile for behaviours outside of the road layout.

The likelihood of each determined goal and motion profile can then be estimated by a likelihood estimator of the level-0 trajectory generator. Likelihood estimation is performed using inverse planning, which generates a set of proposed paths and motion profiles for each goal from a starting state in the past, and extending over a historical time period. Inverse planning is described in further detail in International Patent Publication No. WO 2020/079066, as well as International Patent Application No. PCT/EP2023/050774, both of which are hereby incorporated by reference in their entirety. The resulting paths and motion profiles are then compared with the trajectory actually taken by the agent from that starting state in order to generate a likelihood for the proposed goals and motion profiles.

The goal and motion profile likelihood estimation may be implemented as a neural network, where the network outputs a set of likelihood values corresponding to the proposed goals and motion profiles, and where the network is trained using a classification loss function, such as cross entropy loss, that encourages the network to assign a high likelihood to goals and motion profiles corresponding to the trajectory closest to the actual historical trajectory and a low likelihood to all other goals and motion profiles. Alternatively inverse planning may be implemented by other methods, such as a Rapidly Exploring Random Tree (RRT) model. This method is described in International Patent Publication No. WO 2020/079066.

The level 0 trajectory generation network is implemented as a multi-layer neural network, which processes each of these inputs and outputs a set of trajectories for each agent of the scene. The trajectory generation network is configured to generate a separate trajectory for each of multiple prediction modes, where the number of prediction modes is specified in advance. The network is trained based on a loss function comprising a term to penalise deviations between the predicted trajectory obtained and a ground truth trajectory taken by the agent in a real scenario over the same period. This may be achieved, for example, by performing the trajectory prediction from a past state, such that a ground truth trajectory is the actual trajectory taken by the agent in a time interval immediately following that past state. The loss function selects the trajectory for the ‘closest’ or most similar mode, i.e. the mode whose trajectory is closest to ground truth, and computes the deviation of that trajectory from the ground truth trajectory, based on which the network weights are updated. This encourages the network to learn predicted trajectories close to the actual trajectories of the agents, but allows the network to provide multiple different predictions for different modes.

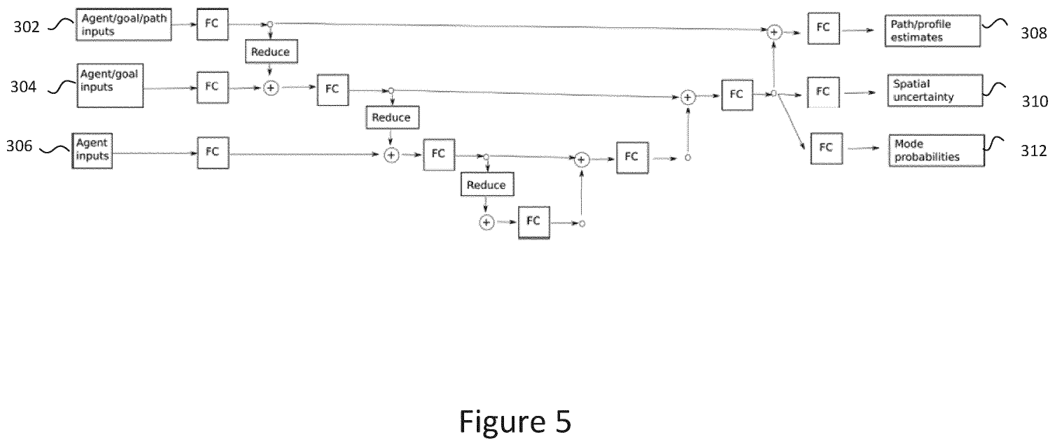

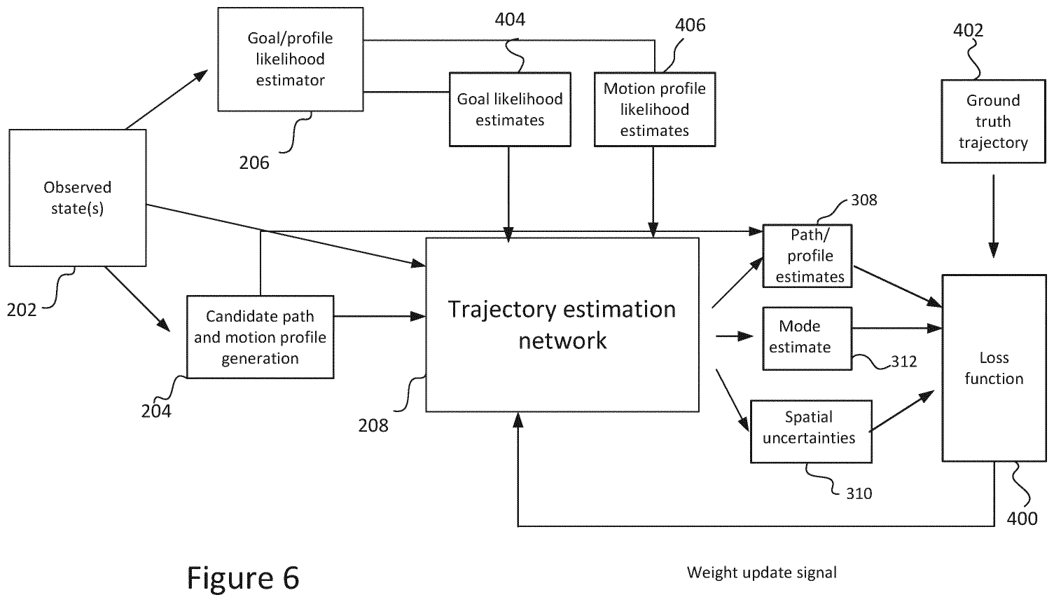

The level-0 trajectory generator 228a outputs a trajectory 212a for each agent. As mentioned above, the trajectory generation network may directly output a trajectory for each agent, having a sequence of states defining the position and motion of each agent over time, or it may output the trajectory in the form of a weighted combination of basis trajectories. The trajectories 212a output by the level-0 trajectory generator are referred to as level-0 trajectories. These represent trajectories of agents with only the static scenario taken into account, i.e. without considering future interactions between agents. These trajectories serve as a basis for higher-level prediction taking interactions between agents into account, as described below. The level-0 trajectory generator 228a also outputs a set of spatial uncertainties associated with each trajectory at each timestep. The spatial uncertainties may be in the form of elliptical Gaussian functions oriented on the yaw angle of the trajectory. The trajectory generator 228a additionally outputs an estimated probability for each prediction mode. The loss function used to train the trajectory generator network may also include a term to maximise the probability of the ‘ground truth’ mode, i.e. the mode whose trajectory corresponds most closely to the ground truth trajectory, and a term to encourage a high probability of the ground truth trajectory according to the spatial uncertainty distribution. Note that the spatial uncertainties and mode probabilities are not specifically shown in FIG. 2 alongside the trajectories output by the network. However, they are shown in the example architecture of FIG. 5. Training of the level-0 trajectory generation network, and other trajectory generation networks of the trajectory generators shown in FIG. 2, is described in further detail below with reference to FIG. 6.

The level-0 trajectories 212a and the associated spatial uncertainties and prediction mode probabilities, are provided to a collision assessment module 210. The collision assessment module 210 computes a likelihood of collision between the different possible trajectories computed by the network 208. The collision assessment comprises computing a degree of overlap between the predicted position of the agents, based on an occupied region of each agent, represented as an ellipse with equal area and proportion as the rectangular occupied region of the agent (where in this example the agent is a vehicle). This can also take into account the spatial uncertainties associated with each level-0 predicted trajectory. The collision assessment may define collision of a trajectory in different ways. For example, the collision assessment for a given trajectory may evaluate to a binary value according to whether or not the associated agent following that trajectory overlaps with any other predicted trajectory for any other agent of the scene. Alternatively, an overall probability value may be determined for each trajectory representing the probability of collision of the associated agent following that trajectory with any other predicted trajectory for any other agent of the scene. The collision assessment is performed per-trajectory, in that a collision value (e.g. a binary indicator of collision, or a probability of collision) is calculated for each predicted trajectory output by the level-0 trajectory generator 228a, i.e. for each prediction mode and for each agent of the scene.

The output of the collision assessment 210 for the level-0 trajectories is then provided as input to the level-1 generator 228b, along with the level-0 trajectories 212a, and spatial uncertainties 310 and mode probabilities 312. The level-1 generator 228b also takes as input each of the observed states 202 and map data 220 defining the static scene. The level-1 trajectory generator 228b comprises a neural network which is trained to take as input the map data 220 and observed states 202, as well as the level-0 trajectories and collision assessment results in the form of a per-trajectory evaluation of collision, and output a new set of trajectories for each agent of the scene. As described above for level 0, in the case that the neural network trajectory generator 228b is configured to output a weighting of basis trajectories, a set of basis paths and motion profiles, as well as agent goals, and associated likelihoods, are computed based on the observed states and map data, and provided as inputs to a neural network of the level 1 generator 228b. These additional inputs are not shown in FIG. 2. At this level, the behaviour of different agents in response to each other is considered. For example, if two level-0 trajectories associated with two agents of the scene are found to overlap, or to have a high collision probability, the level-1 trajectory generation network is likely to output level-1 trajectories 212b for one or both of those agents that take this collision probability into account.

The level-1 trajectory generator 228b is implemented in the form of a neural network having a separate set of weights to the level-0 trajectory generator, and is trained based on ground truth trajectories, using a loss function to encourage the trajectory generator to output trajectories that are close to a ground truth trajectory for the given agent in the training data. The training may be performed by applying the trajectory generator to a training input comprising a past state of a scenario for which a subsequent set of trajectories are known, and comparing the results of the trajectory generator with the ground truth trajectories, and updating the weights of the trajectory generator network so as to minimise the loss defined between the predicted trajectories of the network and the ground truth trajectories. The level-0 trajectory generator and the level-1 trajectory generator differ in architecture in that the level-1 trajectory generator is configured to receive a collision assessment result in addition to the inputs of the level-0 trajectory generator.

The level-1 trajectories 212b, as well as spatial uncertainties and/or trajectory likelihood values are output by the level-1 trajectory generator and are provided to the collision assessment module 210 to perform a collision assessment on each level-1 trajectory as described above for level 0.

The process can be repeated again for any chosen number of prediction levels. As shown in FIG. 2, the results of the collision assessment 210 at level 1 is provided to a level-2 trajectory generator 228c, along with the observed states 202 and map data 220. The collision assessment results received at each level can include collision assessment values for each previous level. In other words, the level-2 trajectory generator receives a set of collision assessment values for each level-0 trajectory, as well as a set of collision assessment values for each level-1 trajectory. Similarly, the level-N trajectory generator receives a set of collision assessment values for each level 0 trajectory, each level-1 trajectory, etc, up to each level N−1 trajectory as generated by the level N−1 trajectory generator. However, the trajectory generation system may instead be configured such that only the collision assessment result for the immediately preceding layer is provided as input to a current layer.

At each level, a separate neural network trajectory generator is trained, having been provided with a different respective input including the current state of the system and a set of collision assessment results for different levels of interaction as determined at previous levels of the hierarchy. This enables the system to perform higher-level reasoning about the behaviour of the agents of the scene, by considering not only how each agent will behave based on their own state and the static state of the scene at the start of the predicted trajectories, but also how each agent will behave based on the different possible ways each other agent could behave. The trajectories output at higher levels of the hierarchy therefore learn to anticipate other agent behaviours and determine trajectories that take more complex interactions into account. The number of levels required for a given scenario may be dependent on the complexity of the scenario, and the system may be configured such that the number of layers can be adjusted according to the given scenario and application.

The process described above continues with the trajectory generator at each level producing trajectories for each agent of the scene based on the observed states 202 of the agents and the map data 220, as well as the collision assessment performed at lower levels of the hierarchy, until a final set of trajectories 212d is generated by the top-level generator 228d according to the pre-defined number of levels.

The inputs to the trajectory generation networks 228a-228d may have different dimensionalities. For example, the set of observed states is defined for each agent of the scene, and define spatial and motion information for each agent over a set of past timesteps, while the collision assessment for a previous level is computed for each prediction mode, and for each agent and defines a collision value (such as an overall probability of collision) for each timestep of the associated trajectory over the set of future timesteps of the trajectory. The multiple inputs are handled by the network by processing each input type by one or more fully connected layers and reducing the results to generate a context representation for the scene. This is shown in FIG. 6.

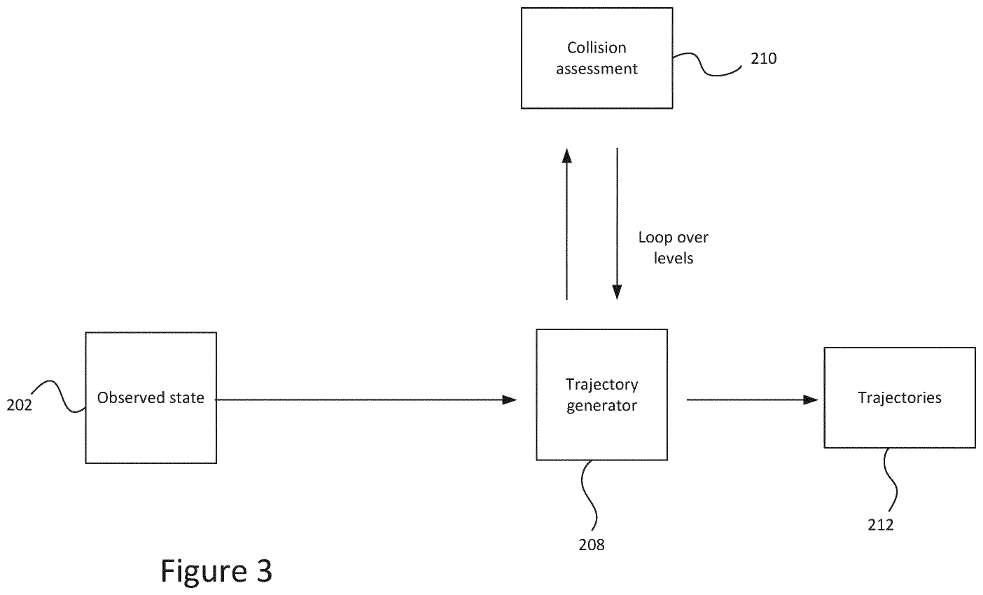

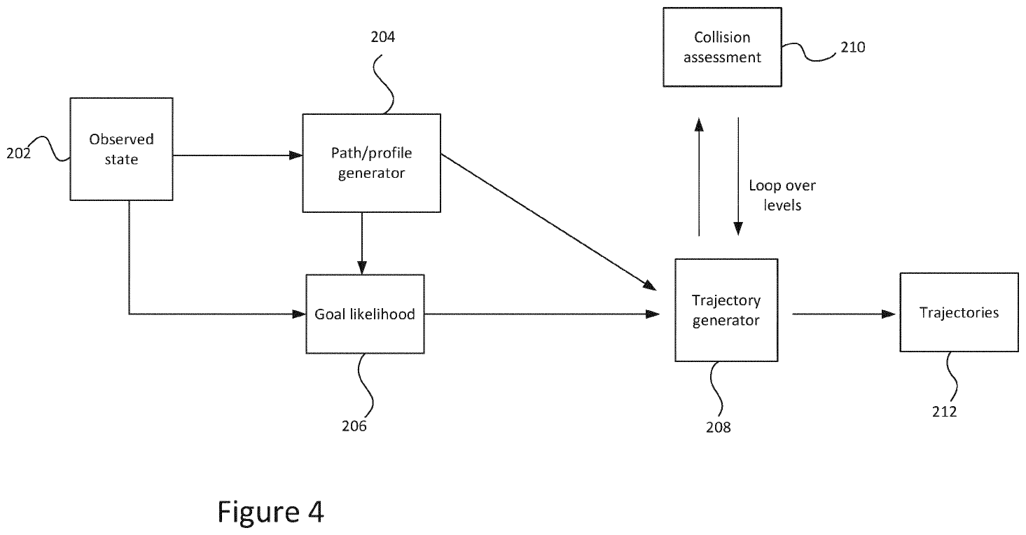

As mentioned above, the form of the trajectory generation neural networks used at each level of the hierarchical system described in FIG. 2 can vary. In one example implementation, the neural networks are trained to directly output a set of trajectories comprising a sequence of positions, orientations, and motion coordinates such as speed, acceleration, etc. In another example implementation, the neural network is trained to output a set of weights defining a weighted combination of basis paths and motion profiles, where the basis paths and motion profiles are generated based on the observed states 202 and map data 220 of the scene. Both implementations are described below with respect to FIGS. 3 and 4.

FIG. 3 shows a schematic block diagram of a hierarchical trajectory generation system implementing a set of trajectory generation networks to directly generate trajectories as a sequence of states of an agent. In this case, the observed state of the scenario 202 is provided directly to the trajectory generator 208. As described above, at each level of the hierarchy, a separate trajectory generator 228 is trained, each having a different set of weights. However, for the purpose of FIG. 3, all trajectory generators are represented by a single trajectory generator component 208, and the multiple levels of the system, as described above, are shown by a loop between the collision assessment module 210 and the trajectory generator 208. The map data describing the static elements of the scene are also provided as input to the trajectory generator 208.

The trajectory generator 208 receives the observed states, map data, and computes a set of trajectories 212 directly for each agent and mode of prediction. For example, given 3 prediction modes, the trajectory generator produces 3 sequences of states for each agent of the scene starting from a ‘current’ timestep, i.e. starting from the state of the scene as provided to the trajectory generator from which to generate the future trajectories of each agent. The trajectory generator 208 can also be configured to generate a set of spatial uncertainties associated with the agent positions of the trajectory, as well as a trajectory likelihood for the trajectories associated with the different prediction modes indicating which trajectory is the most likely for each agent of the scene. As mentioned above, these trajectories are provided to a collision assessment module 210, which produces a collision assessment value for each trajectory output by the trajectory generator 208 at the given level, and this is provided to the trajectory generator 208 at the next level to perform trajectory generation taking an extra level of interaction between agents into account.

After repeating the process over a predefined number of levels, as described above with reference to FIG. 2, a final set of trajectories 212 is generated.

As shown in FIG. 4, a similar architecture is used in the case of a trajectory generator 208 trained to generate weights for a weighted combination of basis paths and motion profiles. However, a path/motion profile generator 204 is applied to determine a set of basis paths and basis motion profiles which are used to form the final trajectories, by applying a trajectory generator trained to determine a weighting of the basis paths and basis motion profiles in order to generate a final trajectory that is kinematically feasible and lies within the bounds of the reasonable paths and motion profiles determined for each agent.

The path/profile generator 204 determines a set of basis paths for a single agent from a given starting position and starting timestep as follows. This may be the timestep corresponding to the most recently observed state. First a set of possible goals are generated for the agent. Goals can be identified from the road layout as described above with reference to FIG. 2.

A set of basis paths are generated for the goals as described above by fitting one or more splines between waypoints of the graph, where the splines extend between waypoints from the starting point to the respective goal waypoint, where the splines may also be fit via one or more intermediate waypoints. More than one basis path may be generated to the same goal waypoint, each representing a different behaviour of the agent. For example, where the goal waypoint is in a neighbouring lane to the start point, such that a lane change is necessary, one possible basis path may complete the lane change over a short distance, while another basis path may perform a longer lane change such that the path moves between the two lanes for a longer distance.

A set of motion profile targets can be generated by identifying a number of target kinematic states, which are defined based on the road speed at each goal, as well as a number of motion profile parameters representing behaviours, such as acceleration and relative speed. The motion profile target specifies the final speed and acceleration of the agent at the respective goal. Basis motion profiles are produced by fitting speed profiles between the initial and target kinematic states using splines. Bezier splines may also be used for generating the basis motion profiles in this way. The basis motion profiles are defined as a set of motion coordinates, such as speed, acceleration and jerk, at each of a set of equally-spaced timesteps up to the motion profile target.

The set of possible goals are passed to a goal/profile likelihood estimator 206, and the basis paths and motion profiles are passed to the trajectory generator network 208. As described above, the goal/profile likelihood estimator 206 generates a set of likelihoods for the possible goals and a set of likelihoods for possible motion profiles associated with those goals using inverse planning.

The goal and profile likelihood estimator 204 determines the most likely goals and motion profiles for agents of the scenario, which are used to inform the trajectory generator network 208 of an appropriate weighting of the basis paths and motion profiles defining the agent's trajectory. For example, in the case where an agent's current state is beginning to move off the road, as described above, a goal is defined representing the intention of that agent to maintain its current course and continue moving away from the road, while another possible basis path may lead the agent from its current state back to the road layout, that path ending in a goal waypoint derived from the lane representation. For initial agent states further from the road layout, the goal and profile likelihood estimator assigns a higher probability to the off-road goal and a lower probability to goals wherein the agent returns to the road layout. These relative likelihoods of the respective goals are then provided as input to the trajectory generation network, which uses the relative likelihood to determine a contribution of the basis paths and motion profiles associated with the respective on-road and off-road goals to the final predicted trajectory of the agent. Therefore, although a set of basis paths are always generated from the road layout, in cases where the agent has moved off-road, the weighting determining the predicted path of the agent may be biased heavily towards the basis paths generated from the current and past states of the agent only, rather than those paths derived from the lane representation of the road layout.

The trajectory generator 208 then generates a trajectory based on the set of inputs, including the observed state 202, map data 220 (not shown), basis paths and motion profiles and goal and motion profile likelihoods, by determining a set of weights to be applied to the basis paths and motion profiles to define a trajectory over a time interval extending from a current timestep into the ‘future’ (where future is defined relative to the point from which the trajectory is planned). The weighting is applied by multiplying the basis paths and motion profiles by their corresponding weights and combining the resulting path and motion profile into a single trajectory for the given agent by deriving distances from the motion profile and interpolating the path such that the position and motion of the agent is defined for each timestep from the starting point until the time the agent reaches the end of the predicted path. It should be noted that instead of generating a separate weighting for the basis paths and the basis motion profiles and then combining them to form a predicted trajectory, a set of basis trajectories may instead be generated by the path/profile generator 204 and a set of weights predicted for the basis trajectories to combine them into a predicted trajectory in the output 212. Further details of a network for generating trajectories as a weighted combination of basis paths and motion profiles are provided in United Kingdom Patent Application No. 2201398.1, which is hereby incorporated by reference in its entirety.

As described above, a collision assessment 210 is performed to generate a per-trajectory collision value which is provided as input to the next level of the trajectory generator 208. At the final level, a set of trajectories 212, as defined by the weighted combination generated by the trajectory generator 208, are output. Multiple trajectories may be generated for each agent, for each of multiple prediction modes. The trajectory generator also determines a likelihood for each trajectory, such that the mode with the highest likelihood can be selected as the trajectory for the given agent.

Further details of the neural network architecture and training will now be described in the context of the ‘basis trajectory’ implementation of FIG. 4, in which the trajectory generator produces a weighted combination of basis paths and motion profiles. However, the same techniques can equally be applied to a trajectory generation network that directly outputs trajectories as a sequence of agent states.

FIG. 5 shows a schematic block diagram showing the structure of a neural network trajectory generator configured to receive inputs of different dimensionalities. This is just one example architecture, which can be adapted according to the inputs of the trajectory generation network for the chosen implementation, as well as the level of the hierarchy described in FIG. 2. The inputs to the network can include inputs that have values for each agent, goal and path. For example, position coordinates are defined for each basis path, where the basis paths as described above are generated for each agent, and where each basis path is associated with a proposed goal. As described above, the paths are generated for each goal based on possible paths to that goal waypoint via the points defined for the lane graph of the drivable region, and therefore the number of paths is variable for different scenarios, agents and goals. In order to process a variable-size input in a neural network, which is configured to receive inputs of a predefined size, a pre-processing step is necessary to generate a standardised representation of the input of a constant dimension. Other inputs may be defined per agent and goal, such as the goal likelihood estimates produced by the goal/profile estimator 206. This is shown in FIG. 5, which shows a system with three input dimensionalities: agent/goal/path inputs 302 which comprise a value for each path, goal and agent, agent/goal inputs 304 which comprise a value for each agent and goal, and agent inputs, which provide a value for each agent (for example the current position of the agent).

The trajectory generator network 208 processes all inputs together by reducing higher dimensional inputs in turn and combining them. First, the agent/goal/path inputs 302 and the agent/goal inputs 304 are modified by applying a fully connected layer to each to produce feature representations for each. The agent/goal/path representation has a dimension for the path that is not present in the next level of the input, and so this representation is reduced along the path dimension to generate a representation matching the dimension of the representation generated at the agent/goal layer and combining the reduced agent/goal/path representation and the agent/goal feature representation, each of which has agent and goal dimensions, to a single representation of the agent/goal inputs. The reduction may be performed, for example, by computing a sum, mean, or max of the feature representation elements for each goal and agent over all the paths, in order to generate a scalar value for each path, giving a representation with agent and goal dimensions which can be combined with the existing agent/goal inputs 304.

The agent inputs 306 and agent/goal combined representation are then processed by respective fully connected layers and the agent/goal representation is similarly reduced to generate further lower-dimensional representations and combined to produce a representation at the agent level. This representation provides features for each agent representing the inputs corresponding to that agent. The number of agents is variable for each scenario, and to be processed by the network, a standard representation of the entire scenario with all agents can be generated by reducing the agent representations along the agent dimension, for example by computing a mean representation over all agents. This method is similar to the concept of word embeddings. A final step performs a reduction along the agent dimension in order to generate an overall context representation for the entire scene.

To generate the outputs 212, the overall context representation describing the entire scene is added as context to the representations generated for each of the inputs at each layer of the hierarchy, and these are processed with further fully connected layers in order to generate the set of outputs, where the mode probabilities 312, path/profile estimates 308 and corresponding spatial uncertainties 310 are defined for each agent and prediction mode. The path/profile estimates, as described above, are output as a set of predicted weights corresponding to each distance step of the basis paths and each time step of the basis motion profiles. The weights are applied to weight each of the basis paths defined for each agent, and the basis motion profiles defined for each agent, in order to generate a full predicted trajectory. It should be noted that, while each basis path and each basis motion profile is associated with a specific goal, the output of the network is not necessarily associated with any single goal. The full set of basis paths and motion profiles generated for all proposed goals of the given agent are used in the weighting of the final predicted path. The weights are normalised to add to one, such that they define a relative contribution of each basis path and basis motion profile to the trajectory, ensuring that the predicted paths and motion profiles at each distance or time step is not more extreme than any single basis path or motion profile. The most ‘extreme’ weighting at any given step assigns a weight of 1 to a single basis path or motion profile, and a weight of 0 to all other paths or motion profiles. This step of generating the trajectory is not shown in FIG. 3, but where a path/profile or trajectory estimate or prediction is referred to herein, it should be noted that it is defined by the set of weights predicted by the network in combination with the basis paths and motion profiles generated by the path/profile generator 204. For a neural network trajectory that directly generates trajectories as a sequence of agent states, the path/profile estimates 308 would be replaced by a set of trajectories, having a trajectory for each agent and mode.

FIG. 6 shows a schematic block diagram of the training of the trajectory estimation network 208. The trajectory estimation network comprises multiple fully connected ‘hidden’ layers, each ‘hidden’ layer comprising a set of ‘neurons’, where a neuron comprises a nonlinear function, often referred to as an activation function. The activation function may be, for example, a rectified linear unit. These functions are well known in the field of machine learning and will not be discussed further herein. The input to each neuron is a weighted sum of the input to the given layer. A layer is described as ‘fully connected’ when the full input to the layer is processed by every neuron of that layer. The weights of the connections between the input layer and each neuron, and between neurons of consecutive hidden layers, are parameters of the neural network model, and these weights are updated in training to encourage the neural network to learn to perform the desired task, which in the present application is a prediction of agent trajectories. The trajectory generator network 208 is trained by starting with a random initialisation of weights, and processing the inputs as described above with reference to FIG. 5 to produce predicted trajectories. To update the weights, a loss function penalising deviations between the predicted trajectories and the ground truth trajectories of the corresponding agents is evaluated, and an update signal is generated for the weights. This may use a form of gradient descent, wherein the weights are updated in the direction of the negative gradient of the loss function with respect to the weights. Gradient descent methods are well known in the field of machine learning for training neural networks and will not be described in detail herein.

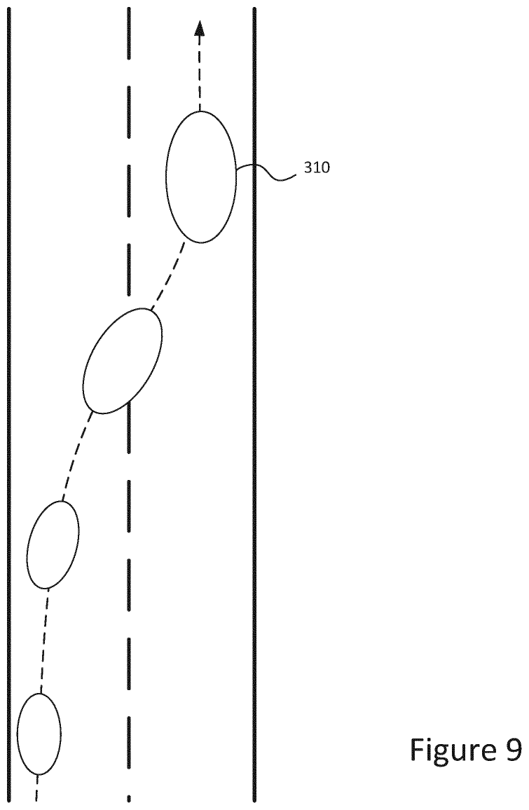

As shown in FIG. 6, the observed state of the scene 202 is passed to both a basis path and motion profile generator 204 which generates a set of basis paths and motion profiles and a goal/profile likelihood estimator 206, which produces a set of goal likelihoods and a set of motion profile likelihoods. The basis paths and motion profiles, goal likelihoods 404, motion profile likelihoods 406, and the observed state 202 of the scenario are passed to the trajectory estimation network 208, which reduces and processes the inputs as described above with reference to FIG. 3, generating a set of predicted path and motion profile weights, which are applied to respective basis path and motion profiles to generate predicted trajectories for each agent and prediction mode, as well as a mode probability estimate, and a spatial uncertainty, which may be in the form of parameters defining an elliptical Gaussian function. An example of a spatial uncertainty produced by the trajectory estimator 208, is shown in FIG. 9. A loss function 400 is defined to encourage the network to learn to predict trajectories that are close to the ground truth trajectories in training. As mentioned above, training may be performed using a training dataset for which the actual trajectories of the agents from a selected starting point in a given scene is already known, where the prediction system is provided with the state of the system up to that starting point from which to make a prediction. The actual trajectories are provided in training as ground truth 402 for computing the loss function. As mentioned above, the loss function may comprise multiple terms associated with the multiple outputs of the network.

The output comprises path and profile estimates 308 (i.e. basis path and motion profile weightings) and spatial uncertainty 310 for each mode, as well as a probability 312 for each mode. A goal of the network is to predict with high probability the best mode, as well as to predict a trajectory for that mode that is close to the actual trajectory taken by the agent. The loss function may therefore simultaneously encourage the probability of the mode closest to the ground truth trajectory to be maximised, and a measure of distance between the predicted trajectory of the best mode and the ground truth trajectory 400 to be minimised, as well as maximising the likelihood of the ground truth trajectory according to the predicted spatial uncertainty distribution. Once the loss function is computed for a given set of training data, an update signal is passed back to the network, and the weights are updated according to the update signal. The update algorithm may use gradient descent, in which the update signal comprises a gradient of the loss function, such that the weights are updated in a direction that minimises the loss. Multiple rounds of updates are performed to iteratively improve the predictions output by the network.

As mentioned above, in this implementation the trajectory generation network 208 does not directly output a predicted trajectory, i.e. a set of position and motion values defining the agents' motion, but instead produces a set of weights to be applied to basis paths and motion profiles generated earlier by the path/motion profile generator 204, described above. However, the loss function is applied to the trajectory generated by applying the weights to the basis paths and motion profiles. As mentioned, this uses map information to generate a set of possible paths within a graph of a drivable region of road and fits both the path and the motion profile to the start and target states for the given goal by fitting splines between points in the graph and between the initial kinematic state and the motion profile target. A relative weighting of these paths and motion profiles ensures that the output of the trajectory estimation network is not more extreme at any given point than the basis paths and motion profiles themselves.

In an alternative implementation in which the trajectory generation network 208 is instead configured to directly output a predicted trajectory in the form of a sequence of agent states, the loss function directly compares a ground truth trajectory with the output of the trajectory generation network and updates the weights according to the computed loss. In this implementation, no candidate path and motion profile generation is performed.

The description above describes steps of a level-0 prediction, where the set of inputs includes only current and past states of the agents of the scene, without consideration of the future motion of other agents of the scene when generating a trajectory for a given agent. Once a set of trajectories is generated at this level, however, these predictions can be used as input to subsequent layers of trajectory generation that takes into account the expected motion of the agents from the level-0 prediction, as described above with reference to FIG. 2. Additionally, a collision assessment is performed on the predictions output at level-0. Training of the neural network trajectory generation network 208 at each subsequent level is performed taking the collision assessment results of each previous level as an additional input.

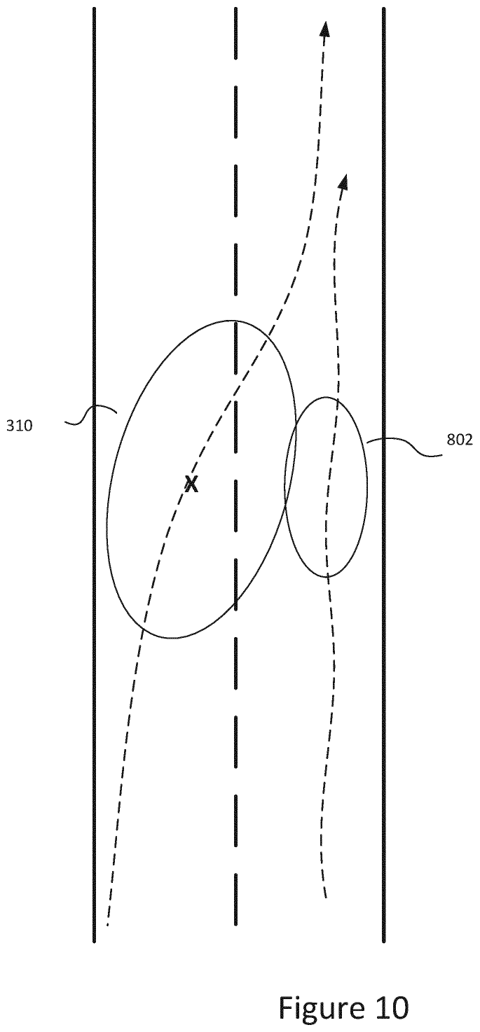

As described above, in some implementations, the collision assessment 210 determines a probability of collision between agents in the scenario by evaluating a degree of overlap of the spatial uncertainty distributions output by the trajectory generation network for a given agent and the occupancy region of other agents, represented as an ellipse. The collision probabilities compute a degree of overlap between all predicted trajectories, considering all modes for each agent, where the collision probability for a given agent is computed by weighting the likelihood of overlap between specific trajectories and the estimated probability of the respective modes that the given trajectories are associated with. A simplified example of this is shown in FIG. 10, where a spatial uncertainty distribution 310 around a predicted position of an agent moving into the right lane is used to compute a probability of collision by evaluating the overlap of the agent in the right lane, represented by an ellipse 802, with the spatial uncertainty distribution of the other agent's position. For each agent, the probability of collision is assessed against all other agents of the scenario and possible trajectories, and an overall probability of collision with any other agent is computed for that agent's trajectory at that timestep. As any given agent has a number of modes, a separate collision assessment is performed for each mode, i.e. for each agent trajectory. However, the probability of collision for any given agent and mode is aggregated over all possible external agent trajectories. The result of the collision assessment is a matrix of probabilities of collision for each agent and mode at each timestep, i.e. a matrix of dimension agents x modes x timesteps.

At the next level of prediction, the trajectory generation network 208 receives as inputs: the observed state of the system, the goal and motion profile likelihoods and the basis paths and motion profiles, as described in FIG. 3 for level-0 prediction, in addition to the outputs of the level-0 prediction, i.e. the generated trajectories, mode probabilities and spatial uncertainties output by the trajectory generation network 208. The basis paths, motion profiles and goal and motion profile likelihoods may be re-computed at level 1, or alternatively the same basis paths and motion profiles that were generated for input to the level-0 network may be used as input for level 1. The level-1 network also receives the collision assessment results based on the evaluation of the predicted trajectories and uncertainty distributions from level-0 prediction. The level-1 trajectory generation network is configured with a slightly different architecture in order to receive these inputs and reduce the representations of the collision assessment inputs and the previous level's predictions with the basis paths and motion profiles and likelihood estimations to reduce the overall representation of the input to a single context representation. For example, the collision assessment output, described above, has dimension agents x modes x timesteps. This is treated as an agent input 306, that has a variable agent dimension, and the modes and timesteps matrix for each agent is appended to the other agent inputs in order to generate the agent representation. The output of the level-1 trajectory generation network is identical to the output of the level-0 trajectory generation network, comprising, for each agent, a set of predicted trajectories with associated spatial uncertainties, as well as a probability for each prediction mode. The level-1 trajectory generation network is also trained by the method described above, using a loss function to encourage the network to predict trajectories close to the actual ground truth trajectory taken by the agent.

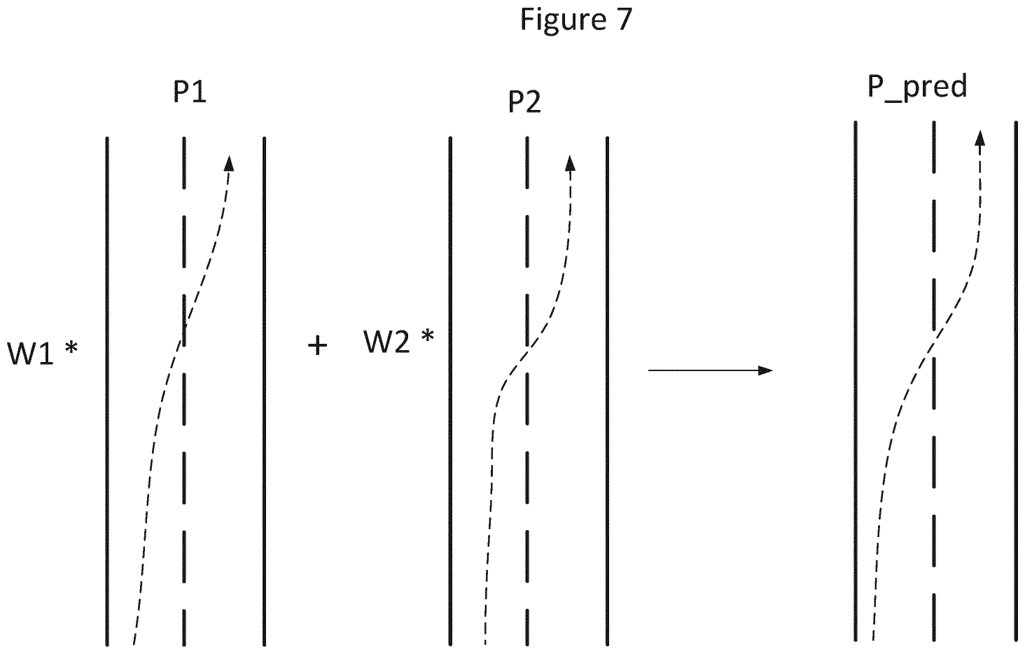

FIG. 7 shows a highly simplified example of a path generated by interpolating a set of two basis paths computed from a starting state in the left lane of a two-lane road section towards a goal in the right lane. Each basis path comprises a matrix of spatial coordinates for the agent (xᵢ, yᵢ) for a given distance along the road section. The trajectory estimation network is trained as described above to generate a set of weights w₁ⁱ, w₂ⁱ corresponding to the positions of the basis paths at a given distance step i. The predicted path can be generated by multiplying the path weights (Wᵢ¹, Wᵢ²) by the respective basis paths and summing the results, thereby generating a new path. This is equivalent to a matrix operation:

$${P}_{pred} = {P}_{1} {\underline{w}}^{1} + {P}_{2} {\underline{w}}^{2} ,$$

where Pⱼ=(x^{j}y^{j}) are the first and second basis paths each comprising vector of position values x^{j}=(x₁^{j}, . . . , xₙ^{j}) and y^{j}=(y₁^{j}, . . . , yₙ^{j}) for each distance step up to the distance n to the goal, and where w^{j}=(w₁^{j}, . . . wₙ^{j}) is a vector of weights corresponding to the respective basis path as defined at each distance step. Pⱼ may additionally comprise elements (cos(yaw), sin(yaw)), to which the learned weights are applied. The weights for each basis path are applied to the components of a unit vector representation of the yaw angle and a weighted average (yaw)_{pred} and (yaw)_{pred} is generated for each component as described above for x and y components, with the yaw angle for P_{pred} determined by applying an arctan function to the ratio of

$$\frac{{( yaw )}_{pred}}{{( yaw )}_{pred}} .$$

As shown in FIG. 7, the first basis path P₁ shows a relatively long lane change from the left to the right lane to reach the given goal, while the second basis path shows the lane change occurring within a shorter distance. The network-predicted weights determines the relative contribution of each of these basis paths at each timestep in the final predicted path P_{pred}. It should be noted that this is a simplified example to illustrate how paths are combined and does not represent a real path. In reality there may be many more basis paths forming the predicted path, and the weights can vary significantly at different distance steps such that the predicted path is not necessarily a direct combination of two full paths.

This illustrative example refers to the path, i.e. the spatial component of the trajectory only. As described above, weights are also generated from the trajectory estimation network 208 for the basis motion profiles, which are fit as splines to a set of kinematic targets, rather than spatial waypoints. While this is not shown in FIG. 7, the combination of motion profiles to form a predicted motion profile is performed in the same way as the weighted sum described to generate a predicted path, wherein the motion profile is a matrix of motion coordinates such as velocity, acceleration over the set of timesteps up to the given goal, and thus weights of the motion profiles are output by the network for each timestep rather than each distance step. Interpolation can be applied to the predicted path in order to estimate a position at each timestep by first determining a set of distances for each timestep of the motion profile, and interpolating the path based on the motion profile. The predicted path and motion profile can then be combined by concatenating the spatial and motion coordinate values at each timestep to generate an overall predicted trajectory for the given agent and goal.

The above description refers to applications of a trajectory generation network to generate predicted trajectories of agents in a scene. This can be used as part of a prediction component of an autonomous vehicle to generate a set of predicted traces of all agents of a scene (including the ego vehicle), based on which a planning component can plan a trajectory for the ego vehicle that takes other agents' goals and future actions into account.

Another possible application of a neural network for predicting weights for a set of basis paths and motion profiles is in the generation of trajectories in a planning component 106 of an autonomous vehicle stack. As described in International Publication No. WO2021/152047, which discloses a planner referred to herein as ‘PILOT’, which is herein incorporated by reference in its entirety, a two-stage planner can be implemented to generate a plan for an ego vehicle towards a predetermined goal in the presence of other agents, where the first stage is a neural network which takes as input a set of predicted traces for the agents of the scene (such as the trajectories generated by the methods described above with reference to FIGS. 1-3).

FIG. 8 shows a block diagram of a neural network for the first stage of the two-stage optimisation planner that generates a trajectory as a combination of basis paths and basis motion profiles generated based on the ego goal. In this case, the ego goal is known, as this is the intended target of the planner, and so a single set of basis paths and basis motion profiles can be determined by fitting splines to the graph representation and the kinematic targets set for example by speed limits within the drivable area as described earlier. The basis path/profile generator 602 receives as input a state of the scene, including a map, and generates the basis paths and motion profiles at a path and motion profile generator 602, which determines a path based on the ego goal as described earlier for the agent goals in the prediction component. Predicted agent trajectories for external (non-ego) agents of the scenario, which could be generated as described above, are received from a prediction component and passed to the ego trajectory estimation network 604. As described in the PILOT application, the neural network uses imitation learning to approximate the results of a constrained non-linear optimisation which provides a solution close to a globally optimal solution used to seed a second non-linear optimisation stage designed to converge to a more optimal plan. While the PILOT application describes the output of the first stage optimiser as a set of trajectory positions over time, or alternatively as parameters of a set of smooth functions, herein, the ego trajectory is configured to produce a set of weights to be applied to the basis paths and motion profiles generated by the basis path/profile generator 602. Once the weights are output by the network, the basis paths and motion profiles can be multiplied by the weights corresponding to the respective positions and kinematic values of the corresponding distance/time steps and summed to generate an ego path and motion profile, and therefore generate an ego trajectory for seeding the second non-linear optimisation stage.

This network is trained as described in the PILOT application, with the additional step of generating the proposed ego trajectory by applying the weights output by the network to the respective basis paths and motion profiles generated earlier before computing the loss function described in the PILOT application, which computes an L2 norm between an ‘expert’ trajectory obtained by non-linear optimisation and the ego trajectory generated based on the network output.

Alternatively, the neural network may be used to directly generate a planned trajectory for the ego agent without further refinement by a second non-linear optimisation stage, where the network is again trained to generate a substantially optimal trajectory for a given set of scenario inputs, such as perception outputs from a perception system and/or predicted behaviour of external agents received from a prediction system 104, by minimising an error between the trajectories generated by the network in training and trajectories generated by an expert planner using, for example, non-linear optimisation.

FIG. 9 shows a representation of the spatial uncertainties output by the network trajectory estimator, overlaid on the example predicted path generated as shown in FIG. 7. As described above, a spatial uncertainty distribution is defined for each timestep and prediction mode. The spatial uncertainty is represented as an elliptical Gaussian centred on the predicted trajectory corresponding to each mode, capturing the uncertainty in the predicted position of the agent in all directions at the given timestep. The mode of the Gaussian is the most probable position of the agent at the given timestep, and the width of the distribution indicates the degree of confidence in the given prediction. The spatial uncertainty distribution can vary with distance, for example uncertainty might increase with the number of timesteps from the current state as more possible futures deviating from the predicted trajectory are possible over time. This is shown by the size of the ellipses in FIG. 5 which increase along the path to the goal. It should be noted that the spatial uncertainty is calculated for each step in time, and not at equal distance measures along the path.

In a planning context, scenario input(s) provided to a neural network trajectory generator may be obtained using a perception system and, in some cases, a prediction system applied to perception outputs (in more modular systems where prediction is separable from planning). In a prediction context, scenario inputs may be obtained using a perception system. The present techniques can also be employed in simulation in various contexts. In one simulation context, the described stack (or part of it) may be applied to simulated inputs (e.g., derived from synthetic sensor data or using scenario models). In another simulation context, the described trajectory generation techniques may be used to generate agent behaviours in a simulation environment for the purpose of testing some other stack, and the scenario inputs may be generated from simulation ground truth as the scenario progresses. For example, the neural network trajectory generator may be applied to a current ground truth state of the simulation to compute the next state.

The above techniques can be implemented in an “onboard” or “offboard” context. The above techniques can also be implemented as part of a simulated runtime stack in order to test the performance of the runtime stack in a simulator. Simulation is an increasingly crucial component of safety and other performance testing for autonomous vehicles in particular.

References herein to components, functions, modules and the like denote functional components of a computer system which may be implemented at the hardware level in various ways. A computer system comprises one or more computers that may be programmable or non-programmable. A computer comprises one or more processors which carry out the functionality of the aforementioned functional components. A processor can take the form of a general-purpose processor such as a CPU (Central Processing unit) or accelerator (e.g. GPU) etc. or more specialized form of hardware processor such as an FPGA (Field Programmable Gate Array) or ASIC (Application-Specific Integrated Circuit). That is, a processor may be programmable (e.g. an instruction-based general-purpose processor, FPGA etc.) or non-programmable (e.g. an ASIC). A computer system may be implemented “onboard” a mobile robot (such as an AV) or “offboard” for example in a simulator context.

1. A computer-implemented method of generating a trajectory for a first agent of a plurality of agents navigating a mapped area, the method comprising:
receiving an observed state of each of the plurality of agents, and map data of the mapped area;
generating an initial estimated trajectory for each of the plurality of agents based on the observed state of each agent and the map data;
performing a first collision assessment to determine a likelihood of collision between the first agent and each other agent, based on the initial estimated trajectory for the first agent and the initial estimated trajectory for each other agent; and
generating a second estimated trajectory for the first agent based on the observed states of each of the plurality of agents, the map data, and at least one result of the first collision assessment.

2. The method according to claim 1, wherein the initial estimated trajectory is generated by a first neural network configured to receive the observed state of each agent and the map data as inputs, and wherein the second estimated trajectory is generated by a second neural network, wherein the second neural network is configured to receive the observed state of each agent, the map data, and the collision assessment results.

3. The method according to claim 1, comprising:
generating a second estimated trajectory for each of the plurality of agents based on the observed state of each agent and the map data;
performing a second collision assessment to determine a likelihood of collision between the first agent and each other agent of the plurality of agents, based on the second estimated trajectory for each of the plurality of agents; and
generating a third estimated trajectory for the first agent based on the observed states of each of the plurality of agents, the map data, and the results of the second collision assessment.

4. The method according to claim 3, wherein the third estimated trajectory is further based on the results of the first collision assessment.

5. The method according to claim 1, wherein each of the estimated trajectories comprises a series of states for the respective agent, the states defining position and motion of the agent.

6. The method according to claim 2, wherein generating each of the estimated trajectories comprises generating, by the respective neural network, a set of weights corresponding to a set of trajectory basis elements, weighting each trajectory basis element by its corresponding weight and combining the weighted trajectory basis elements to generate a trajectory.

7. The method according to claim 2, wherein generating each of the estimated trajectories comprises directly generating, by the respective neural network, a time sequence of states defining the trajectory of the agent.

8. The method according to claim 1, wherein the first or second collision assessment comprises computing a collision probability defining a probability that an agent following the estimated trajectory collides with any other agent of the plurality of agents following any of that agent's respective estimated trajectories.

9. The method according to claim 6, wherein the trajectory basis elements comprise multiple basis paths and weighted basis paths are combined to form a path, the estimated trajectory comprising the path.

10. The method according to claim 6, wherein the trajectory basis elements comprise multiple basis motion profiles and weighted basis motion profiles are combined to form a motion profile, the estimated trajectory comprising the motion profile.

11. The method according to claim 10, wherein the basis motion profiles are generated based on the observed state of the first agent and one or more motion profile parameters.

12. The method according to claim 1, applied to plan a trajectory for an ego agent, wherein the first agent is the ego agent and the trajectory generation comprises generating a candidate planned trajectory for the ego agent.

13. The method according to claim 12, wherein the candidate planned trajectory is used to seed a runtime optimizer that generates a final planned trajectory for the agent.

14. (canceled)

15. A computer system for generating a trajectory for a first agent of a plurality of agents navigating a mapped area, the computer system comprising:
one or more processors; and
memory coupled to the one or more processors, the memory embodying computer-readable instructions, which, when executed on the one or more processors, cause the one or more processors to:
receive an observed state of each of the plurality of agents, and map data of the mapped area;
generate an initial estimated trajectory for each of the plurality of agents based on the observed state of each agent and the map data;
perform a first collision assessment to determine a likelihood of collision between the first agent and each other agent, based on the initial estimated trajectory for the first agent and the initial estimated trajectory for each other agent; and
generate a second estimated trajectory for the first agent based on the observed states of each of the plurality of agents, the map data, and at least one result of the first collision assessment.

16. A non-transitory computer readable medium embodying computer program instructions, the computer program instructions configured so as, when executed on one or more hardware processors, to implement operations comprising:
receiving a set of training data comprising a set of training inputs, each input comprising an observed state of each of a plurality of agents, and map data of a mapped area, and a corresponding ground truth outputs, each ground truth output comprising an actual trajectory from the observed state of a first agent of the plurality of agents;
processing the observed state of each agent and the map data in a first neural network to generate an initial estimated trajectory for each of a plurality of agents;
performing a collision assessment to determine a likelihood of collision between the first agent and each other agent, based on the initial estimated trajectory for the first agent and the initial estimated trajectory for each other agent;
processing the observed states of each of the plurality of agents, the map data, and the collision assessment results in a second neural network to generate a second estimated trajectory for the first agent; and
computing an update to parameters of each of the first and second networks of the based on a loss function that penalises deviations between the initial estimated trajectory for the first agent and the corresponding ground truth output for the first agent, and deviations between the second estimated trajectory for the first agent and the corresponding ground truth output for the first agent.

17. The computer system according to claim 15, wherein the initial estimated trajectory is generated by a first neural network configured to receive the observed state of each agent and the map data as inputs, and wherein the second estimated trajectory is generated by a second neural network, wherein the second neural network is configured to receive the observed state of each agent, the map data, and the collision assessment results.

18. The computer system according to claim 15, wherein the memory embodying computer-readable instructions, which, when executed on the one or more processors, additionally cause the one or more processors to:
generate a second estimated trajectory for each of the plurality of agents based on the observed state of each agent and the map data;
perform a second collision assessment to determine a likelihood of collision between the first agent and each other agent of the plurality of agents, based on the second estimated trajectory for each of the plurality of agents; and
generate a third estimated trajectory for the first agent based on the observed states of each of the plurality of agents, the map data, and the results of the second collision assessment.

19. The computer system according to claim 15, wherein the initial estimated trajectory is generated by a first neural network configured to receive the observed state of each agent and the map data as inputs, and wherein the second estimated trajectory is generated by a second neural network, wherein the second neural network is configured to receive the observed state of each agent, the map data, and the collision assessment results.

20. The computer system according to claim 15, wherein the memory embodying computer-readable instructions, which, when executed on the one or more processors, additionally cause the one or more processors to:
generate a second estimated trajectory for each of the plurality of agents based on the observed state of each agent and the map data;
perform a second collision assessment to determine a likelihood of collision between the first agent and each other agent of the plurality of agents, based on the second estimated trajectory for each of the plurality of agents; and
generate a third estimated trajectory for the first agent based on the observed states of each of the plurality of agents, the map data, and the results of the second collision assessment.

21. The computer system according to claim 20, wherein the third estimated trajectory is further based on the results of the first collision assessment.
